(19) United States
(12) Patent Application Publication
(10) Pub. No.: US 2007/0281207 A1
(43) Pub. Date: Dec. 6, 2007

(54) Prevention of lithium deposition in nonaqueous electrolyte cells by matching device usage to cell capacity

(76) Inventors: Esther S. Takeuchi, East Amherst, NY (US); Randolph Leising, Williamsville, NY (US)

Correspondence Address: Michael F. Scalise;Wilson Greatbatch Technologies, Inc., 9645 Wehrle Drive, Clarence, NY, 14031, US

(21) Appl. No.: 11/007,939

(22) Filed: Dec. 9, 2004

Related U.S. Application Data
(60) Provisional application No. 60/528,257, filed on Dec. 9, 2003.
(60) Provisional application No. 60/528,259, filed on Dec. 9, 2003.

(51) Int. Cl. H01M 6/36

(52) U.S. Cl. 429/112

(57) ABSTRACT

The prevention of lithium clusters from bridging between the negative and positive portions of a cell during discharge is described. This is done by matching the pulse-discharged capacity of a primary lithium cell powering a therapy device to one where should lithium clusters form, the total lithium cluster surface area will be less than the nominal gap distance between a positive polarity member and a negative polarity member.

### CROSS-REFERENCE TO RELATED APPLICATIONS

This application claims priority from provisional application Ser. Nos. 60/528,257 and 60/528,259, both filed Dec. 9, 2003.

### BACKGROUND OF THE INVENTION

1. Field of the Invention

The present invention generally relates to the conversion of chemical energy to electrical energy. More particularly, this invention is directed to preventing lithium from bridging between the positive and negative portions of a cell during discharge, particularly high rate intermittent pulse discharge. Such lithium bridging is referred to as a “lithium cluster” and should it occur, an internal loading mechanism that prematurely discharges the cell could result.

2. Prior Art

The mechanism controlling lithium deposition between the positive and negative cell portions of a case negative primary lithium electrochemical cell, such as between the cathode lead and casing, is described in the publication by Takeuchi, E. S.; Thiebolt, W. C. J. Electrochem. Soc. 138, L44-L45 (1991). While this report specifically discusses measurements made on the lithium/silver vanadium oxide (Li/SVO) system, it also applies to other solid insertion type cathodes used in lithium cells where voltage decreases with discharge.

According to the investigators, lithium deposition is induced by a high rate intermittent discharge of a Li/SVO cell and can form “clusters” bridging between the negative case and the positive connection to the cathode. This conductive bridge can then result in an internal loading mechanism that prematurely discharges the cell.

The mechanism for lithium cluster formation is as follows: at equilibrium, the potential of a lithium anode is governed by the concentration of lithium ions in the electrolyte according to the Nernst equation. If the Li⁺ ion concentration is increased over a limited portion of the electrode surface, then the electrode/electrolyte interface in this region is polarized anodically with respect to the electrode/electrolyte interface over the remaining portion of the electrode. Lithium ions are reduced in this region of higher concentration and lithium metal is oxidized over the remaining portion of the electrode until the concentration gradient is relaxed. The concentration gradient is also relaxed by diffusion of lithium ions from the region of high concentration to low concentration. However, as long as a concentration gradient exists, deposition of lithium is thermodynamically favored in the region of high lithium ion concentration.

In a Li/SVO cell, Li⁺ ions are discharged at the anode and subsequently intercalated into the cathode. The anode and cathode are placed in close proximity across a thin separator. Immediately after a pulse discharge, the Li⁺ ion concentration gradient in the separator is dissipated as the Li⁺ ions diffuse the short distance from the anode to the cathode and then within the pore structure of the cathode. However, at the electrode assembly edge, the anode edge is not directly opposed by the cathode edge. If excess electrolyte pools at this edge, Li⁺ ions, which are discharged into the electrolyte pool, have a longer distance to diffuse to the cathode than Li⁺ ions discharged into the separator. Consequently, this electrolyte pool maintains a higher concentration of Li⁺ ions for a longer period of time after the pulse discharge.

Typically, the lithium anode tab is welded to the inside of the cell casing. Therefore, if these components are also wetted by excess electrolyte, this concentration gradient extends over the tab and casing, and lithium cluster deposition is induced onto these surfaces by the Nernstian anodic potential shift derived from the higher Li⁺ ion concentration in the excess electrolyte pool after the pulse discharge.

### SUMMARY OF THE INVENTION

Accordingly, the present invention relates to matching the therapy utilized by an implantable cardiac defibrillator (ICD), or other implantable medical device that requires high power, to the capacity of a high rate lithium cell used to power the device. Specifically, by matching the discharged capacity of a primary lithium cell powering a therapy device, the formation of detrimental lithium deposition extending between the anode tab/casing and a positive polarity portion such as a cathode and the terminal pin in the cell is avoided. Lithium deposition is undesirable since it can lead to a conductive bridge forming between the negative and positive portions inside the cell and, thus, result in premature cell depletion. This lithium deposition has been shown to depend on the rate of cell discharge, which, in turn, depends on the level of therapy provided by the device.

These and other aspects of the present invention will become more apparent to those skilled in the art by reference to the following description and to the appended drawings.

### BRIEF DESCRIPTION OF THE DRAWINGS

FIG. 1 is a partial sectional view of an exemplary electrochemical cell 10 according to the present invention.

FIG. 2 is a graph of the electrical performance of a model 8830 Li/SVO cell pulse discharged with two 0.5-ampere pulses per day for 216 days.

FIG. 3 is a graph of the electrical performance of a model 8830 Li/SVO cell pulse discharged with twelve 1.5-ampere pulses per day for 12 days.

FIG. 4 is a graph of the average electrical performance of two model 8830 Li/SVO cells pulse discharged with four 1.5-ampere pulses per day for 40 days.

FIG. 5 is a graph of the average electrical performance of two model 8830 Li/SVO cells pulse discharged with twelve 2.5-ampere pulses per day for 8 days.

FIG. 6 is a graph of the lithium cluster surface area versus % DoD removed from a cell/train for thirty model 8830 Li/SVO cells subjected to various pulse discharge protocols.

### DETAILED DESCRIPTION OF THE PREFERRED EMBODIMENTS

A lithium cluster is the result of a higher Li⁺ ion concentration in the electrolyte immediately adjacent to a surface creating an anodically polarized region resulting in the reduction of lithium ions on the surface as the concentration gradient relaxes. Typically, a lithium ion concentration gradient is induced by the high rate, intermittent discharge of a lithium/solid cathode active chemistry, such as a lithium/silver vanadium oxide cell.

The term percent depth-of-discharge (% DoD) is defined as the ratio of delivered capacity to theoretical capacity, times 100.

The term “pulse” means a short burst of electrical current of significantly greater amplitude than that of a pre-pulse current or open circuit voltage immediately prior to the pulse. A pulse train consists of at least one pulse of electrical current. The pulse is designed to deliver energy, power or current. If the pulse train consists of more than one pulse, they are delivered in relatively short succession with or without open circuit rest between the pulses. An exemplary pulse train may consist of one to four 5 to 20-second pulses with about a 2 to 30 second rest, preferably about 15 second rest, between each pulse. A typically used range of current densities for cells powering implantable medical devices is from about 15 mA/cm² to about 50 mA/cm², and more preferably from about 18 mA/cm² to about 35 mA/cm². Typically, a 10 second pulse is suitable for medical implantable applications. However, it could be significantly shorter or longer depending on the specific cell design and chemistry and the associated device energy requirements. Current densities are based on square centimeters of the cathode electrode.

An electrochemical cell according to the present invention must have sufficient energy density and discharge capacity in order to be a suitable power source for an implantable medical device. Contemplated medical devices include implantable cardiac pacemakers, defibrillators, neurostimulators, drug pumps, ventricular assist devices, and the like.

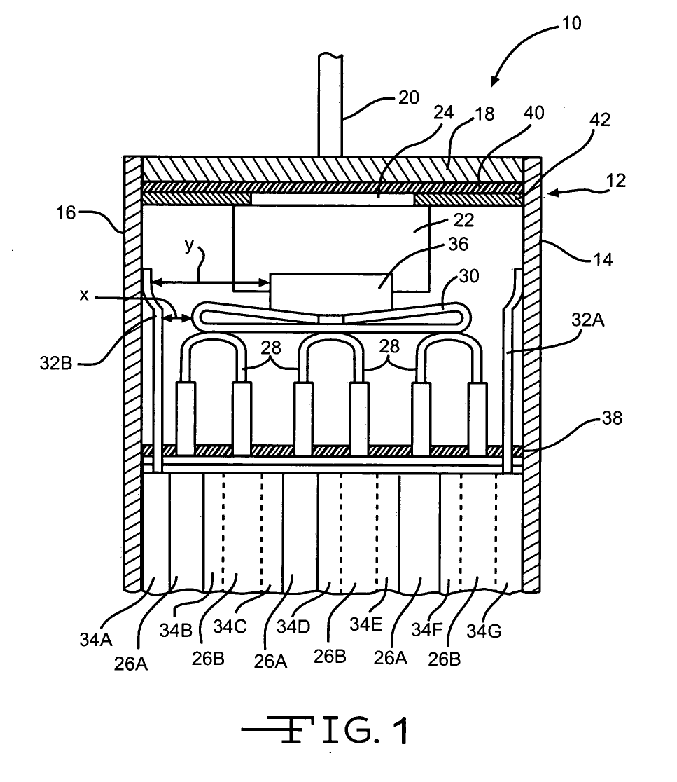

Referring now to the drawings, FIG. 1 shows an electrochemical cell 10 for delivering high current pulses and particularly suited as a power source for an implantable medical device such as a cardiac defibrillator. Cell 10 includes a hollow casing 12 having spaced apart sidewalls 14, 16 extending to spaced apart end walls (not shown) and a bottom wall (not shown). Casing 12 is closed at the top by a lid 18 welded to the sidewalls and end walls in a known manner. Casing 12 is of metal such as stainless steel, and being electrically conductive provides one terminal or contact for making electrical connection between the cell and its load. Lid 18 also is of stainless steel. The other electrical terminal or contact is provided by a conductor or pin 20 extending from within the cell 10 through casing 12, and in particular through lid 18. An insulator cup 22 of a polymeric material such as HALAR or TEFZEL surrounds and partially encases the ferrule 24 of a glass-to-metal seal structure. As is well known by those skilled in the art, the pin 20 is electrically insulated from the metal lid 18 by the glass-to-metal seal. A plug (not shown) closes an electrolyte fill opening in lid 18.

The cell 10 includes a cathode of a twin cathode plate structure comprising two cathode plates 26A and 26B joined together by an intermediate connector 28. The cathode plates 26A and 26B comprise cathode active bodies contacted to two cathode current collector portions joined by the intermediate conductor portion 28. In the drawing, there is illustrated a cell stack assembly comprising a plurality of these cathode structures. A manifold 30 is connected to each of the intermediate conductors 28. By way of example, the cathode current collectors may be in the form of a thin sheet of metal foil or screen, for example titanium, stainless steel, tantalum, platinum, gold, aluminum, cobalt nickel alloys, nickel-containing alloys, highly alloyed ferritic stainless steel containing molybdenum and chromium, and nickel-, chromium- and molybdenum-containing alloys. The conductor 28 is of a similar material and is in the form of a solid thin tab extending from one cathode current collector screen to the other.

The cathode plates 26A and 26B contain a solid cathode active material that may be of a carbonaceous chemistry or comprise a metal element, a metal oxide, a mixed metal oxide, a metal sulfide, and combinations thereof. The metal oxide, the mixed metal oxide and the metal sulfide are formed by the chemical addition, reaction, or otherwise intimate contact of various metal oxides, metal sulfides and/or metal elements, preferably during thermal treatment, sol-gel formation, chemical vapor deposition or hydrothermal synthesis in mixed states. The active materials thereby produced contain metals, oxides and sulfides of Groups, IB, IIB, IIIB, IVB, VB, VIB, VIIB and VIII, which includes the noble metals and/or other oxide and sulfide compounds. A preferred cathode active material is a reaction product of at least silver and vanadium.

One preferred mixed metal oxide is a transition metal oxide having the general formula SMₓV₂O_{y} where SM is a metal selected from Groups IB to VIIB and VIII of the Periodic Table of Elements, wherein x is about 0.30 to 2.0 and y is about 4.5 to 6.0 in the general formula. By way of illustration, and in no way intended to be limiting, one exemplary cathode active material comprises silver vanadium oxide having the general formula AgₓV₂O_{y} in any one of its many phases, i.e., β-phase silver vanadium oxide having in the general formula x=0.35 and y=5.8, γ-phase silver vanadium oxide having in the general formula x=0.80 and y=5.40 and ε-phase silver vanadium oxide having in the general formula x=1.0 and y=5.5, and combinations and mixtures of phases thereof. For a more detailed description of such cathode active materials reference is made to U.S. Pat. Nos. 4,310,609 and 4,391,729, both to Liang et al., U.S. Pat. No. 5,545,497 to Takeuchi et al., U.S. Pat. No. 5,695,892 to Leising et al., U.S. Pat. No. 6,221,534 to Takeuchi et al., U.S. Pat. No. 6,413,669 to Takeuchi et al., U.S. Pat. No. 6,558,845 to Leising et al., U.S. Pat. No. 6,566,007 to Takeuchi et al, U.S. Pat. No. 6,685,752 to Leising et al., U.S. Pat. No. 6,696,201 to Leising et al., and U.S. Pat. No. 6,797,017 to Leising et al., which are assigned to the assignee of the present invention and incorporated herein by reference.

Another preferred composite transition metal oxide cathode active material is copper silver vanadium oxide (CSVO), which is described in U.S. Pat. No. 5,472,810 to Takeuchi et al. and U.S. Pat. No. 5,516,340 to Takeuchi et al. Both are assigned to the assignee of the present invention and incorporated herein by reference.

Another cathode active material is a carbonaceous compound prepared from carbon and fluorine, which includes graphitic and nongraphitic forms of carbon, such as coke, charcoal or activated carbon. Fluorinated carbon is represented by the formula (CFₓ)ₙ wherein x varies between about 0.1 to 1.9 and preferably between about 0.5 and 1.2, and (C₂F)ₙ wherein the n refers to the number of monomer units, which can vary widely. When the active material is a fluorinated carbon, the titanium cathode current collector has a thin layer of graphite/carbon material, iridium, iridium oxide or platinum applied thereto.

Additional cathode active materials include V₂O₅, MnO₂, LiCoO₂, LiNiO₂, LiMn₂O₄, TiS₂, Cu₂S, FeS, FeS₂, Ag₂O, Ag₂O₂, CuF₂, Ag₂CrO₄, copper oxide, copper vanadium oxide, and mixtures thereof.

Before fabrication into the cathode plates 26A and 26B, the cathode active material is preferably mixed with a binder material such as a powdered fluoro-polymer; more preferably powdered polytetrafluoroethylene or powdered polyvinylidene flouride present at about 1 to about 5 weight percent of the cathode mixture. Further, up to about 10 weight percent of a conductive diluent is preferably added to the cathode mixture to improve conductivity. Suitable materials for this purpose include acetylene black, carbon black and/or graphite or a metallic powder such as powdered nickel, aluminum, titanium and stainless steel. The preferred cathode active mixture thus includes a powdered fluoro-polymer binder present at about 3 weight percent, a conductive diluent present at about 3 weight percent and about 94 weight percent of the cathode active material.

The anode comprises a continuous elongated element or structure of alkali metal, preferably lithium or lithium alloy, enclosed within a separator material and folded into a plurality of sections interposed between the twin plate cathode plates. In particular, the anode comprises an elongated continuous ribbon like anode current collector (not shown) in the form of a thin metal screen, for example nickel. The anode current collector includes two tabs 32A and 32B extending from opposite side edges thereof. The anode further comprises a pair of elongated ribbon-like lithium sheets pressed together against opposite sides of the anode current collector. These lithium sheets are substantially equal in width and length to the anode current collector with the result that the anode is of a sandwich-like construction. The anode is enclosed or wrapped in an envelope of separator material (not shown), for example polypropylene or polyethylene, and folded at spaced intervals along its length to form a serpentine-like structure that receives the plurality of twin plate cathode structures between the folds to form the cell stack assembly.

In particular, the anode is folded at spaced intervals to provide anode plates 34A, 34B, 34C, 34D, 34E, 34F and 34G along the length thereof. Three sets of the twin plate cathode plates 26A and 26B described above are received between adjacent anode plates to form the cell stack assembly that is received in the cell casing 12. While three sets of the twin cathode plates are shown, it is understood that any number of plate structures may be utilized in the cell stack depending on the cell requirements. Of course, if more or less than three sets of twin cathode plates are use, the anode plates are adjusted accordingly.

The conductor pin 20 extending through the glass-to-metal seal and electrically isolated from the casing 12 is formed into a bend such that its proximal end snugly fits into one end of a coupling sleeve secured by welding to an intermediate lead 36. The intermediate lead 36 is, in turn, connected to the manifold 30 such as by welding.

A cell stack insulator 38 in the form of a thin plate of a polymeric material rests on top of the upper edges on the cathode plates and the serpentine anode. The insulator 38 is provided with slots that receive the cathode connectors 28 and the anode tabs 32A and 32B as it is slipped onto the cell stack in an orientation perpendicular to the plane of the drawing. Insulator 38 is provided to prevent internal electrical short circuits and, by way of example, can be of HALAR or TEFZEL material.

A shield element 40 is positioned adjacent to and in contact with the inner surface of lid 24. This shield is in the form of a thin plate-like strip, elongated rectangularly, and of a size and configuration to cover the surface of lid 18 and provided with openings to accommodate the glass-to-metal seal 30. A second, similarly sized shield element 42 is adjacent to and in contact with shield 40. The shields 40 and 42 protect the internal components of cell 10 including the electrolyte within casing 12 from heat during welding of lid 18 to casing 12 and the fill plug into the electrolyte fill opening in the lid. By way of example, shield 40 is of stainless steel and shield 42 is of mica.

While the invention has been described with the anode and cathode in the form of alternating plates, that is by way of example only. The cell stack may also comprise the cathode in the form of a strip wound with a corresponding strip of anode material in a structure similar to a “jellyroll” or be of a multiplate construction with anode plates.

In order to prevent internal short circuit conditions, the cathode is separated from the anode by a suitable separator material. The separator is of electrically insulative material, and also is chemically unreactive with the anode and cathode active materials and both chemically unreactive with and insoluble in the electrolyte. In addition, the separator material has a degree of porosity sufficient to allow flow there through of the electrolyte during the electrochemical reaction of the cell. Illustrative separator materials include fabrics woven from fluoropolymeric fibers including polyvinylidine fluoride, polyethylenetetrafluoroethylene, and polyethylenechlorotrifluoroethylene used either alone or laminated with a fluoropolymeric microporous film, non-woven glass, polypropylene, polyethylene, glass fiber materials, ceramics, a polytetrafluoroethylene membrane commercially available under the designation ZITEX (Chemplast Inc.), a polypropylene membrane commercially available under the designation CELGARD (Celanese Plastic Company, Inc.), a membrane commercially available under the designation DEXIGLAS (C.H. Dexter, Div., Dexter Corp.), and a membrane commercially available under the designation TONEN.

The electrochemical cell further includes a nonaqueous, ionically conductive electrolyte that serves as a medium for migration of ions between the anode and the cathode electrodes during electrochemical reactions of the cell. The electrochemical reaction at the electrodes involves conversion of ions in atomic or molecular forms that migrate from the anode to the cathode. Thus, the nonaqueous electrolyte is substantially inert to the anode and cathode materials, and exhibits those physical properties necessary for ionic transport, namely, low viscosity, low surface tension and wettability.

A suitable electrolyte has an inorganic, ionically conductive salt dissolved in a nonaqueous solvent, and more preferably, an ionizable lithium salt dissolved in a mixture of aprotic organic solvents comprising a low viscosity solvent and a high permittivity solvent. The salt serves as the vehicle for migration of the anode ions to intercalate or react with the cathode active materials and suitable salts include LiPF₆, LiBF₄, LiAsF₆, LiSbF₆, LiClO₄, LiO₂, LiAlCl₄, LiGaCl₄, LiC(SO₂CF₃)₃, LiN(SO₂CF₃)₂, LiSCN, LiO₃SCF₃, LiC₆F₅SO₃, LiO₂CCF₃, LiSO₆F, LiB(C₆H₅)₄, LiCF₃SO₃, and mixtures thereof.

Useful low viscosity solvents include esters, linear and cyclic ethers and dialkyl carbonates such as tetrahydrofuran, methyl acetate, diglyme, trigylme, tetragylme, dimethyl carbonate, 1,2-dimethoxyethane, 1,2-diethoxyethane, 1-ethoxy, 2-methoxyethane, ethyl methyl carbonate, methyl propyl carbonate, ethyl propyl carbonate, diethyl carbonate, dipropyl carbonate, and mixtures thereof. Suitable high permittivity solvents include cyclic carbonates, cyclic esters, cyclic amides and a sulfoxide such as propylene carbonate, ethylene carbonate, butylene carbonate, acetonitrile, dimethyl sulfoxide, dimethyl formamide, dimethyl acetamide, γ-valerolactone, γ-butyrolactone, N-methyl-pyrrolidinone, and mixtures thereof. In the present invention, the preferred anode active material is lithium metal, the preferred cathode active material is SVO and the preferred electrolyte is 0.8M to 1.5M LiAsF₆ or LiPF₆ dissolved in a 50:50 mixture, by volume, of propylene carbonate and 1,2-dimethoxyethane.

The metallic casing may comprise materials such as stainless steel, mild steel, nickel-plated mild steel, titanium, tantalum or aluminum, but not limited thereto, so long as the metallic material is compatible for use with components of the cell. The glass used in the glass-to-metal seal is of a corrosion resistant type having up to about 50% by weight silicon such as CABAL 12, TA 23, FUSITE 425 or FUSITE 435. The positive terminal pin preferably comprises titanium although molybdenum, aluminum, nickel alloy, or stainless steel can also be used. The cell lid is typically of a material similar to that of the casing. The cell is thereafter filled with the electrolyte solution described hereinabove and hermetically sealed such as by close-welding a stainless steel ball over the fill hole, but not limited thereto.

According to the present invention, the therapy utilized by an implantable medical device that requires high power, is matched to the capacity of the high rate lithium cell used to power the device. For example, an implantable cardiac defibrillator is a device that requires a power source for a generally medium rate, constant resistance load component provided by circuits performing functions such as the heart sensing and pacing. This is a medical device monitoring function that requires electrical current of about 1 microampere to about 100 milliamperes. From time-to-time, the cardiac defibrillator may require a generally high rate, pulse discharge load component that occurs, for example, during charging of a capacitor in the defibrillator for the purpose of delivering an electrical shock to the heart to treat tachyarrhythmias, the irregular, rapid heartbeats that can be fatal if left uncorrected. This medical device therapy function requires about 1 ampere to about 4 amperes, which is a significantly greater than the monitoring function requirements.

In the present invention, the pulse-discharged capacity of the primary lithium cell is matched to the device therapy function such that should lithium clusters form, the total lithium cluster surface area will be less than the nominal gap distance between a positive polarity member and a negative polarity member of the cell. In that respect, criteria have been established which define a critical lithium cluster as one that is large enough to bridge the gap between a negative polarity portion, such as the casing, and a positive polarity portion, such as the cathode bridge (lead) of the primary lithium cell. In a model 8830 cell commercially available from Wilson Greatbatch Technologies, Inc, Clarence, N.Y., the cathode lead is centered over the cell stack leaving 0.081 inches from the case wall to the lead. In some instances, the cathode lead is as close as about 0.053 inches to the case wall. The orientation and location of a critical cluster must also be defined. A critical cluster must be located in the region of the cell where the case wall and the cathode lead are nearest in proximity and must be oriented perpendicularly to the case wall. All three criteria, size, location and orientation must be met in order for a cluster to be classified as critical.

Referring back to FIG. 1, distance “x” is the nominal gap between the positive manifold 30 and the negative leads 32A and 32B. In some cell designs, an insulator (not shown) covers the intermediate conductor portions 28 and the manifold 30. However, there can still be left exposed some portion of the intermediate lead 36. In that case, the critical gap distance “y” is the same as the nominal gap “x” between this positive lead and the negative leads 32A and 32B or the casing sidewalls 14 and 16. As previously discussed, in a model 8830 Li/SVO cell the nominal distance between the positive lead 36 and the casing sidewall can be as close as 0.053 inches. This means that the critical size of a lithium cluster is 0.053 inches.

Other cell designs have greater or lesser nominal gaps that dictate what is a critical lithium cluster for them. Regardless of the critical gap distance “y” in a particular primary lithium cell model, the cumulative discharged capacity delivered in a 24-hour period must be about 2% DoD, or less. This discharge capacity will predominantly be in the form of pulse discharge current because, as previously discussed, it is such an occurrence that establishes conditions favorable for the formation of lithium clusters. That is an anodically polarized region in the cell that is favorable for the reduction of lithium ions on a polarized surface as the concentration gradient relaxes. More preferably, the cumulative discharge capacity delivered by the cell in the 24-hour period is about 1% DoD, or less.

There are several ways that energy can be removed from the cell to meet these requirements. For example, the discharge can consist of multiple short pulses that cumulatively remove less than about 2% DoD and, more preferably, less than about 1% DOD of capacity. Another way is to discharge the cell to deliver one longer pulse in the 24-hour period that is less than about 2% DoD and, more preferably, less than about 1% DoD of capacity. Still another method is to discharge the cell to deliver a combination of shorter pulses together with one medium to long pulse that cumulatively result in less than about 2% DoD and, more preferably, less than about 1% DoD of capacity being removed.

For a primary lithium cell of 1.0 Ah capacity, multiple short pulses can be applied to the cell totaling up to about 170 J to remove about 2% DOD, or totaling up to about 85 J to remove about 1% DOD of capacity. An example of multiple short pulses for a 1.0 Ah cell is the application of 12 pulses, 2 seconds in duration, at an average current draw of 3 amps to remove about 2% DOD of capacity from the cell. Those skilled in the art will understand that there are many permutations that fit this multiple pulse discharge regime for a 1.0 Ah lithium cell, i.e., 24 pulses of 1-second duration. Another example would be to remove energy equal to about 2% DOD from the 1.0 Ah lithium cell in the form of one pulse of up to about 170 J, or to remove about 1% DOD in the form of a single pulse of about 85 J. An example of a single, relatively long pulse per train would be the application of a 3 amp average current for 24 seconds to remove about 2% DOD from the cell. Likewise, a single pulse of 3 amps for 12 seconds would remove about 1% DOD of capacity from the cell. In addition, a lower current, such as one averaging about 2.0 to 2.5 amps, can be used with longer pulse lengths while still limiting the removed energy from about 1% DOD to about 2% DOD. Also, the current can vary during the pulse. This would be where the current starts relatively high and then is lowered during continuation of the pulse to maintain a constant voltage and to limit cell polarization. Combinations of these discharge regimes can be used to limit the amount of capacity removed from the 1.0 Ah cell from about 2% DOD (20 mAh) to about 1% DOD (10 mAh).

For a primary lithium electrochemical cell of 1.5 Ah capacity, multiple short pulses can be applied to the cell totaling up to about 260 J to remove about 2% DOD, or totaling about 130 J to remove about 1% DOD of capacity. An example of multiple short pulses for a 1.5 Ah cell is the application of 18 pulses, 2 seconds in duration, at an average current draw of 3 amps to remove about 2% DOD of capacity from the cell. Those skilled in the art will understand that there are many other permutations that fit this multiple pulse discharge regime for a 1.5 Ah lithium cell, i.e., 36 pulses of 1-second duration. Another example would be to remove energy equal to about 2% DOD from the 1.5 Ah lithium cell in the form of one pulse of up to about 260 J, or to remove about 1% DOD in the form of a pulse of about 130 J. An example of a single, relatively long pulse per train would be the application of a 3 amp average current for 36 seconds to remove about 2% DOD from the cell. Likewise, a single pulse of 3 amps for 18 seconds would remove about 1% DOD from the battery. In addition, a lower current, such as one averaging about 2.0 to 2.5 amps, can be used with longer pulse lengths while still limiting the remove energy from about 1% DOD to about 2% DOD. Also, the current can vary during the pulse. This would be where the current starts relatively high and then is lowered during the continuation of the pulse to maintain a constant voltage and to limit the amount of cell polarization. Combinations of these discharge regimes can be used to limit the amount of removed capacity from the 1.5 Ah cell from about 2% DOD (30 mAh) to about 1% DOD (15 mAh).

For a primary lithium cell of 2.0 Ah capacity, multiple short pulses can be applied to the cell totaling up to about 340 J to remove about 2% DOD, or totaling about 170 J to remove about 1% DOD of capacity. An example of this is the application of 24 pulses, 2 seconds in duration, at an average current draw of 3 amps to remove about 2% DOD of capacity from the cell. Those skilled in the art will understand that there are many permutations that fit this multiple pulse discharge regime for a 2.0 Ah lithium cell, i.e., 48 pulses of 1-second duration. Another example is to remove energy equal to about 2% DOD from the 2.0 Ah lithium cell in the form of one pulse of up to about 340 J, or to remove about 1% DOD in the form of a single pulse of about 170 J. An example of a single, relatively long pulse per train would be the application of a 3 amps average current for 48 seconds to remove about 2% DOD from the cell. Likewise, a single pulse of 3 amp for 24 seconds would remove about 1% DOD from the cell. In addition, a lower current, such as one averaging about 2.0 to 2.5 amps, can be used with longer pulse lengths while still limiting the removed energy from about 1% DOD to about 2% DOD. Also, the current can vary during the pulse. This is where the current starts relatively high and then is lowered during the continuation of the pulse to maintain a constant voltage and to limit the amount of cell polarization. Combinations of these discharge regimes can be used to limit the amount of capacity removed from the 2.0 Ah cell from about 2% DOD (40 mAh) to about 1% DOD (20 mAh).

In a broader sense, an exemplary cell has from about 1.0 Ah to about 4.0 Ah of capacity and the discharge is regulated such that the cumulative discharge capacity is from about 20 mAh to about 80 mAh to remove about 2% DoD from the cell in a 24-hour period. If it is desired to remove only about 1% DoD from the cell in a 24-hour period with the cell having from about 1.0 Ah to about 4.0 Ah of capacity, the cumulative discharge capacity is from about 10 mAh about 40 mAh in the 24-hour period.

While the preferred form of the cell is a case-negative design, the cell can also be constructed in a case-positive configuration. In that case, the cathode active material is contacted to the casing by any one of a number of techniques including pressing a powdered mixture of the cathode active mixture to the inner surface of the sidewalls. Other means include forming a freestanding sheet of the cathode active mixture as described in U.S. Pat. Nos. 5,435,874 and 5,571,640, both to Takeuchi et al., that is then press contacted to the inner surface of the casing sidewalls, or by a thermal spay deposited technique, as described in U.S. Pat. No. 5,716,422 to Muffoletto et al. These patents are assigned to the assignee of the present invention and incorporated herein by reference. In either the jellyroll or prismatic electrode assembly, there is a conductor extending from the casing sidewall or the electrode active material contacted thereto, whether of the anode or the cathode, to the other portions of the same polarity electrode not in direct contact with the casing.

The following examples describe the present invention, and they set forth the best mode contemplated by the inventors of carrying out the invention, but they are not to be construed as limiting.

### EXAMPLE I

Twelve prismatic, hermetically sealed model 8830 Li/SVO defibrillator cells were obtained. All twelve cells, designated as Group I, underwent a typical initial stabilization or “burn-in” period at 37° C. This consisted of the application of a 2.49 KΩ load for seventeen hours. One week after the burn-in period, an acceptance pulse train consisting of four ten-second, 2-amp pulses with fifteen seconds rest between each pulse was applied to the cells.

After burn-in and acceptance pulse testing, the cells were drained of 0.60 Ah of capacity with pulse trains of various amplitudes and pulses per train applied once daily. Each cell was pulse discharged statically on its side, serial number side up, at 37° C. The columns in Tables 1 to 3 indicate the pulse amplitude in amperes and the rows indicate the number of pulses applied per pulse train per day. The entered values in Table 1 signify the number of days the cells remained on test. One cell was discharged according to each specified test condition.

TABLE 1
Experimental Protocol for Group I Cells

| | | Pulse Amplitude | | |
|---|---|---|---|---|
| | | 0.5 A | 1.0 A | 1.5 A |
| Pulse/Train | 2 | 216 | 108 | 72 |
| | 4 | 108 | 54 | 36 |
| | 8 | 54 | 27 | 18 |
| | 12 | 36 | 18 | 12 |

After the application of the specified number of pulse trains, the Group I cells were destructively analyzed. The header was removed from each cell and the extent of lithium cluster formation quantified. The size and location of lithium clusters found on the lid, the insulating strap, and at the top of the cell above the cell stack was measured and recorded. The length and width of each lithium cluster was measured on a Reichert Scientific Instruments Stereo Star Zoom microscope at 40× magnification using a micrometer reticle with one hundred 0.001-inch divisions. Table 2 presents the results of the lithium cluster surface area of each cell in square inches, as determined by the above measuring technique. Table 3 presents the results from Table 2 converted into % DoD removed by pulsing

TABLE 2
Lithium Cluster Surface Area of Group I Cells

| | | Pulse Amplitude | | |
|---|---|---|---|---|
| | | 0.05 A | 1.0 A | 1.5 A |
| Pulses/Train | 2 | 0.0010 | 0.0010 | 0.0015 |
| | 4 | 0.0012 | 0.0017 | 0.0021 |
| | 8 | 0.0037 | 0.012 | 0.023 |
| | 12 | 0.0025 | 0.027 | 0.030 |

TABLE 3
% DoD Removed By Pulsing The Group I Cells

| | | Pulse Amplitude | | |
|---|---|---|---|---|
| | | 0.5 A | 1.0 A | 1.5 A |
| Pulse/Train | 2 | <0.01% | 0.2% | 0.4% |
| | 4 | 0.01% | 0.5% | 0.7% |
| | 8 | 0.02% | 0.95% | 1.4% |
| | 12 | 0.04% | 1.4% | 2.1% |

The cell that received two 0.05-ampere pulses per day for 216 days (<1% DoD) and the cell that received two 1.0-ampere pulses per day for 108 days (0.2% DoD) contained the smallest amount of lithium cluster formation. The lithium cluster surface area determined for each cell was about 0.0010 in². The largest lithium cluster surface area of 0.030 in² (2.1% DoD) was formed in the cell pulsed with twelve 1.5-ampere pulses for twelve days. This was the only Group I cell outside the criteria of having a cumulative delivered capacity in a 24-hour period greater than 2% DoD.

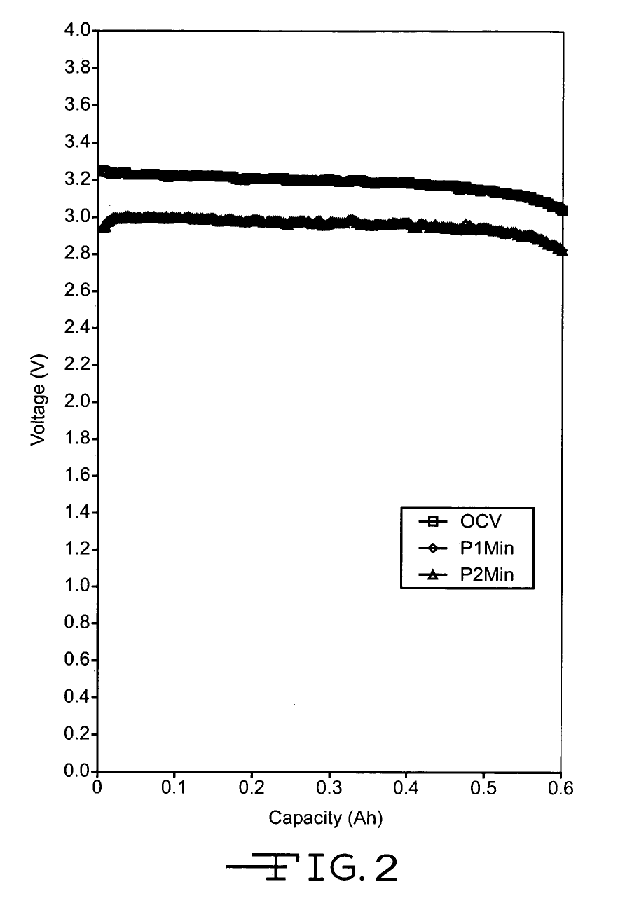

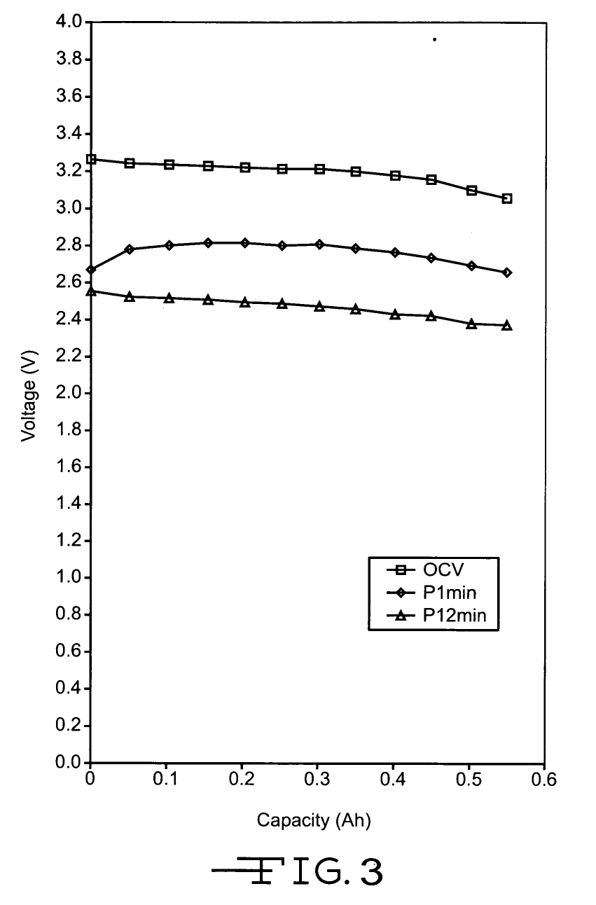

FIGS. 2 and 3 present the electrical data obtained for selected ones of the Group I cells by plotting cell open circuit voltage (OCV), first pulse minimum (P₁ min), and last pulse minimum (Pₗₐₛₜ min) versus cell capacity. FIG. 2 is a graph of the discharge data of the Group I cell pulse discharged with two 0.5-ampere pulses per day for 216 days and containing the least amount of lithium cluster formation. FIG. 3 is a graph of the discharge data for the Group I cell pulse discharged with twelve 1.5-ampere pulses per day for 12 days (2.1% DoD) and containing the largest amount of lithium cluster formation. One general trend in the data can be identified. The lithium cluster surface area increases as the number of pulses per train and the pulse amplitude increase for most of the cells in Group I.

### EXAMPLE II

Eighteen standard model 8830 cells, designated as Group II, were subjected to burn-in and acceptance pulse testing in a similar manner as the cells described in Example I. Each cell was then pulse discharged statically on its side, serial number side up, at 37° C. The cells were drained of 0.66 Ah of capacity with pulse trains of various amplitudes and pulses per train applied once daily. The columns in Tables 3 to 6 indicate the pulse amplitude in amperes and the rows indicate the number of pulses applied per pulse train per day. The entered values in Table 4 signify the number of days the cells remained on test. Two cells were discharged according to each specified test condition.

TABLE 4
Experimental Protocol for Group II

| | | Pulse Amplitude | | |
|---|---|---|---|---|
| | | 1.5 A | 2.0 A | 2.5 A |
| Pulse train | 4 | 40 | 30 | 24 |
| | 8 | 20 | 15 | 12 |
| | 12 | 13 | 10 | 8 |

The results of destructively analyzing the Group II cells and the quantified extent of lithium cluster formation are presented in Tables 5 and 6. The values entered in the Table 5 represent the average lithium cluster surface area in square inches of the two cells, as determined by the same measuring technique used in Example I. Table 6 presents the results from Table 5 converted into % DoD removed by pulsing.

TABLE 5
Average Lithium Cluster Surface Area of Group II Cells

| | | Pulse Amplitude | | |
|---|---|---|---|---|
| | | 1.5 A | 2.0 A | 2.5.A |
| Pulses/Train | 4 | 0.005 | 0.018 | 0.033 |
| | 8 | 0.019 | 0.037 | 0.033 |
| | 12 | 0.035 | 0.048 | 0.063 |

TABLE 6
% DoD Removed By Pulsing The Group II Cells

| | | Pulse Amplitude | | |
|---|---|---|---|---|
| | | 1.5 A | 2.0 A | 2.5 A |
| Pulses/Train | 4 | 0.70% | 0.95% | 1.2% |
| | 8 | 1.40% | 1.9% | 2.4% |
| | 12 | 2.10% | 2.8% | 3.6% |

The cells containing an average lithium cluster surface area of 0.005 in² (0.70% DoD) exhibited the least amount of lithium cluster formation. These cells were pulse discharged with four 1.5-ampere pulses per day for 40 days. The greatest average lithium cluster surface area of 0.063 in² (3.6% DoD) was for the cells pulse discharged with twelve 2.5-ampere pulses per day for eight days. Further, under this pulsing protocol the cells discharged with eight 2.5 A pulses per day for 8 days and all of the cells discharged with 12 pulses per day at 1.5 A, 2.0 A and 2.5 A were outside the criteria of having a cumulative delivered capacity in a 24-hour period greater than 2% DoD.

Five of the 18 Group II cells contained lithium clusters that matched the three previously discussed critical cluster criteria. One each of the two cells pulse discharged with four 2.5-ampere pulses, eight 2.0-ampere pulses, and twelve 2.0-ampere pulses per day contained critical lithium clusters. Both of the cells whose pulse discharge regime consisted of twelve 2.5-ampere pulses per day contained critical lithium clusters.

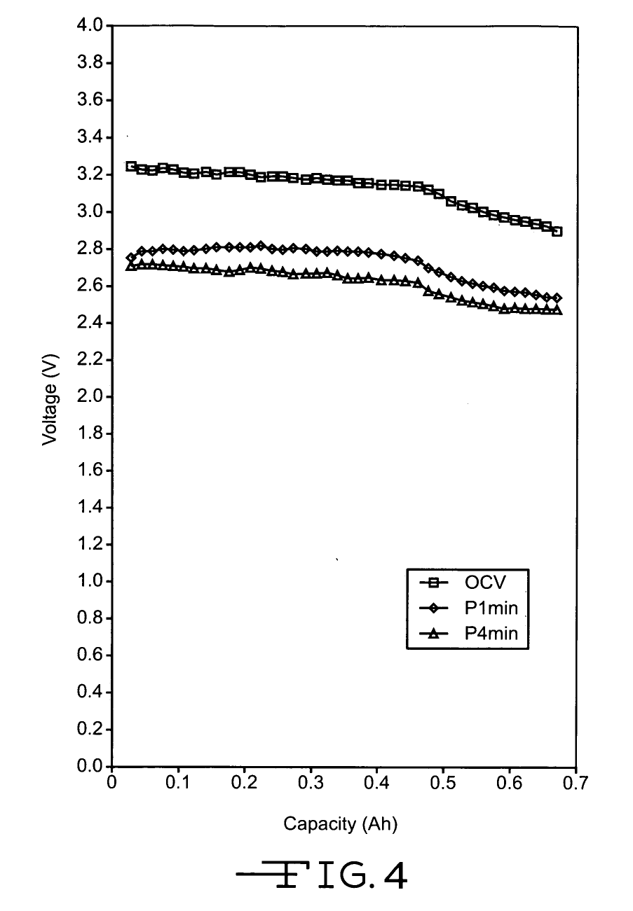

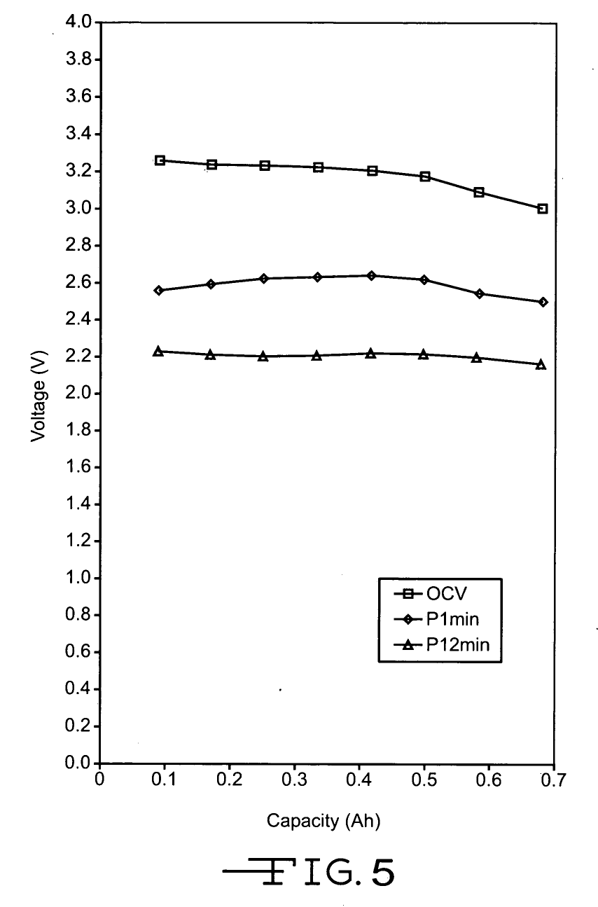

FIGS. 4 and 5 present the electrical data obtained for selected ones of the Group II cells by plotting cell open circuit voltage (OCV), first pulse minimum (P₁ min), and last pulse minimum (Pₗₐₛₜ min) versus cell capacity. FIG. 4 is a graph of the average discharge data of the Group II cells pulse discharged with four 1.5-ampere pulses per day for 40 days and containing the least amount of lithium cluster formation. FIG. 5 is a graph of the average discharge data of the Group II cells pulse discharged with twelve 2.5-ampere pulses per day for eight days and containing the largest amount of lithium cluster formation.

The general trend identified in the Group I cell data is also present in the Group II cell data. As the number of pulses per train and the pulse amplitude increases, the lithium cluster surface area increases.

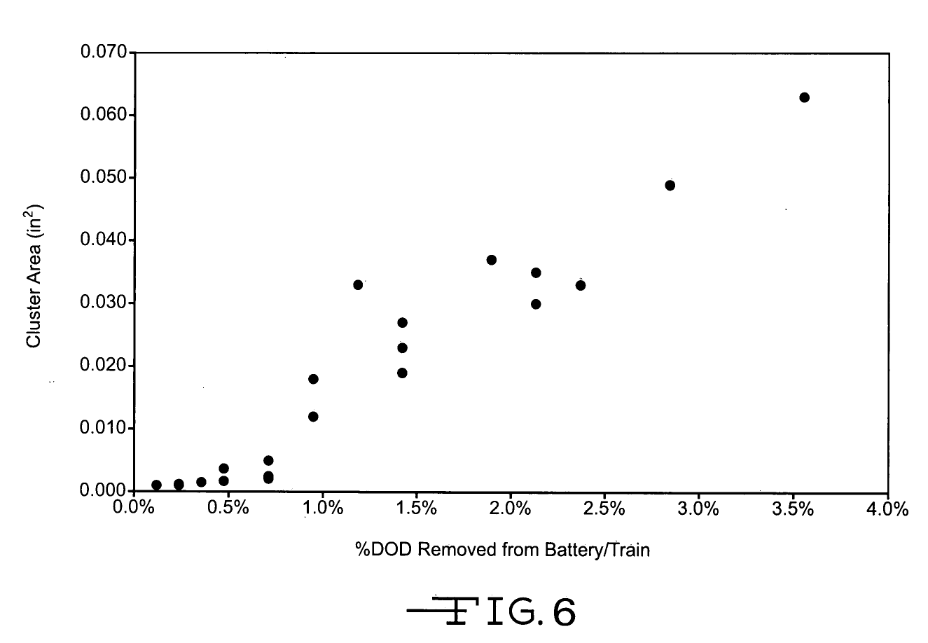

To further explore the relationship between pulse amplitude, the number of pulses per train, and lithium cluster surface area, the Groups I and II cell data was combined and a plot of the average lithium cluster surface area versus capacity per pulse train was generated. This is shown in FIG. 6 where the relationship between lithium cluster surface area and the % DoD removed from the cell/pulse train is graphed. In general, as the capacity/pulse train increases, lithium cluster surface area increases. More specifically, lithium cluster surface area increases as the number of pulses per train and pulse amplitude increases. The smallest quantity of lithium clusters formed in the Group I cell pulse discharged with two 0.5-ampere pulses per day for 216 days and the largest quantity of lithium clusters formed in the Group II cells pulse discharged with twelve 2.5-ampere pulses per day for eight days. Five of the thirty cells tested contained critical lithium clusters. The pulse discharge regimes of these cells had either a significant number of pulses applied per train, significant pulse amplitude, or both.

The conclusion is that when the cumulatively removed discharge capacity is less than about 2% DOD and, more preferably, less than about 1% DOD, the lithium clusters that form are not large enough to constitute ones of a critical size. A critical lithium cluster is one that is large enough to bridge between the positive and negative portions of the cell. Should lithium cluster bridging occur, it could result in an internal loading mechanism that prematurely discharges the cell.

It is appreciated that various modifications to the inventive concepts described herein may be apparent to those of ordinary skill in the art without departing from the scope of the present invention as defined by the appended claims.

1. A method for powering an implantable medical device, comprising the steps of:
a) providing a casing comprising a container having a sidewall extending to an opening closeable by a lid;
b) positioning an anode inside the container, the anode comprising lithium supported on an anode current collector and connecting the anode to the container as negative polarity portions of the cell;
c) positioning a cathode inside the casing, the cathode comprising a cathode active material supported on a cathode current collector and connecting the cathode to a positive terminal pin as positive polarity portions of the cell, wherein the positive terminal pin is electrically insulated from the casing;
d) closing the container with a lid and activating the anode and the cathode with an electrolyte;
e) discharging the cell to power the implantable medical device during both a medical device monitoring function requiring electrical current of about 1 microampere to about 100 milliamperes and a medical device therapy function requiring electrical current of about 1 ampere to about 4 amperes; and
f) upon the occurrence of a medical device therapy function, discharging the cell so that its cumulative capacity delivered to the medical device in a 24-hour period is about 2% DoD, or less so that should a lithium cluster form inside the casing, it will have a size less than a nominal gap distance between a positive polarity portion and a negative polarity portion of the cell.

2. (canceled)

3. The method of claim 1 including discharging the cell to deliver a relatively short burst of electrical current of a greater amplitude than that of a pre-pulse current or open circuit voltage immediately prior to the pulse during the medical device therapy function.

4. The method of claim 1 including discharging the cell to deliver a relatively short burst of electrical current of about 15 mA/cm² to about 50 mA/cm² during the medical device therapy function.

5. The method of claim 1 including discharging the cell to deliver a pulse train of one to four 5- to 20-second pulses of about 15 mA/cm² to about 50 mA/cm² with about a 2 to 30 second rest between each pulse during the medical device therapy function.

6. The method of claim 1 including discharging the cell to power the implantable medical device selected from the group consisting of a cardiac pacemaker, a cardiac defibrillator, a drug pump, a neurostimulator and a ventricular assist device.

7. The method of claim 1 including discharging the cell in the 24-hour period to deliver 12 pulses, 2 seconds in duration, at an average current draw sufficient to remove about 2% DOD of capacity from the cell during the medical device therapy function.

8. The method of claim 1 including discharging the cell in the 24-hour period to deliver 24 pulses of 1-second duration at an average current draw sufficient to remove about 2% DOD of capacity from the cell during the medical device therapy function.

9. The method of claim 1 including discharging the cell in the 24-hour period to deliver a single pulse to remove about 1% DOD during the medical device therapy function.

10. The method of claim 1 including discharging the cell in the 24-hour period to deliver a single pulse to remove about 2% DOD from the cell during the medical device therapy function.

11. The method of claim 1 including discharging the cell in the 24-hour period to deliver a single pulse with the current varying during the pulse to remove about 2% DOD or less of capacity from the cell during the medical device therapy function.

12. The method of claim 1 including selecting the cathode active material from the group consisting of silver vanadium oxide, copper silver vanadium oxide, V₂O₅, MnO₂, LiCoO₂, LiNiO₂, LiMn₂O₄, TiS₂, Cu₂S, FeS, FeS₂, Ag₂O, Ag₂O₂, CuF₂, Ag₂CrO₄, copper oxide, copper vanadium oxide, and mixtures thereof.

13. The method of claim 1 including providing the anode in a serpentine configuration with the cathode comprising cathode plates positioned between the folds of the wind.

14. The method of claim 1 including providing a plurality of cathode plates having their current collectors connected to a manifold connected to the positive terminal pin.

15. A method for powering an implantable medical device, comprising the steps of:
a) providing a casing comprising a container having a sidewall extending to an opening closeable by a lid;
b) positioning an anode inside the container, the anode comprising lithium supported on an anode current collector and connecting the anode to the container as negative polarity portions of the cell;
c) positioning a cathode inside the casing, the cathode comprising a cathode active material supported on a cathode current collector and connecting the cathode to a positive terminal pin as positive polarity portions of the cell, wherein the positive terminal pin is electrically insulated from the casing;
d) closing the container with a lid and activating the anode and the cathode with an electrolyte;
e) discharging the cell to power the implantable medical device during both a medical device monitoring function requiring electrical current of about 1 microampere to about 100 milliamperes and a medical device therapy function requiring electrical current of about 1 ampere to about 4 amperes; and
f) wherein the cell has a known capacity in Ah and upon the occurrence of a medical device therapy function, a cumulative discharge capacity delivered to the medical device is about 2% DoD, or less in a 24-hour period.

16. The method of claim 15 wherein the cell has from about 1.0 Ah to about 4.0 Ah of capacity and including regulating the cumulative discharge capacity from about 20 mAh to about 80 mAh to remove about 2% DoD from the cell in the 24-hour period during the medical device therapy function.

17. The method of claim 15 wherein the cell has from about 1.0 Ah to about 4.0 Ah of capacity and including regulating the cumulative discharge capacity from about 10 mAh to about 40 mAh to remove about 1% DoD from the cell in the 24-hour period during the medical device therapy function.

18. A method for powering an implantable medical device, comprising the steps of:
a) providing a casing comprising a container having a sidewall extending to an opening closeable by a lid;
b) positioning an anode inside the container, the anode comprising lithium supported on an anode current collector and connecting the anode to the container as negative polarity portions of the cell;
c) positioning a cathode inside the casing, the cathode active material comprising silver vanadium oxide supported on a cathode current collector and connecting the cathode to a positive terminal pin as positive polarity portions of the cell, wherein the positive terminal pin is electrically insulated from the casing;
d) closing the container with a lid and activating the anode and the cathode with an electrolyte;
e) discharging the cell to power the implantable medical device during both a medical device monitoring function requiring electrical current of about 1 microampere to about 100 milliamperes and a medical device therapy function requiring electrical current of about 1 ampere to about 4 amperes; and
f) upon the occurrence of a medical device therapy function, discharging the cell such that a cumulative discharge capacity delivered to the medical device in any 24-hour period is about 2% DoD, or less.

19. The method of claim 18 wherein the cell has from about 1.0 Ah to about 4.0 Ah of capacity and including regulating the cumulative discharge capacity from about 20 mAh to about 80 mAh to remove about 2% DoD from the cell in the 24-hour period during the medical device therapy function.

20. The method of claim 18 wherein the cell has from about 1.0 Ah to about 4.0 Ah of capacity and including regulating the cumulative discharge capacity from about 10 mAh to about 40 mAh to remove about 1% DoD from the cell in the 24-hour period during the medical device therapy function.

21. The method of claim 1 including discharging the cell to power the implantable medical device requiring electrical current of about 1 microampere to about 100 milliamperes during the medical device monitoring function requiring and requiring electrical current of about 1 ampere to about 4 amperes during the medical device therapy function.
